(19) United States
(12) Patent Application Publication
(10) Pub. No.: US 2005/0214623 A1
(43) Pub. Date: Sep. 29, 2005

(54) Lightweight fuel cell plates

(76) Inventor: Roberto E. Jerez, Hacienda Heights, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/948,683

(22) Filed: Sep. 22, 2004

Related U.S. Application Data
(60) Provisional application No. 60/504,834, filed on Sep. 22, 2003.

(51) Int. Cl. H01M 8/02; H01M 8/10; B29C 43/18

(52) U.S. Cl. 429/38; 429/30; 264/260; 264/272.14; 429/13

(57) ABSTRACT

A plate member for a fuel cell or fuel cell stack can include conductive elements mounted in a polymeric or crystalline thermoplastic material for use in the relatively higher temperature hydrogen/air-type fuel cells. Additionally, the plate can include additives to increase the thermal conductivity thereof. For example, the fuel cell plate can include carbon fiber and/or carbon particles to increase the thermal conductivity of the plastic used. Additionally, conductive elements mounted to the plates can be preformed with connector members so as to enhance the speed of a manufacturing process.

### PRIORITY INFORMATION

This application is based on and claims priority to U.S. Provisional Patent Application No. 60/504,834 filed Sep. 22, 2003, the entire contents of which is hereby expressly incorporated by reference.

### BACKGROUND OF THE INVENTION

1. Field of the Invention

The inventions disclosed herein generally relate to features of fuel cells for generating electrical power, and in particular, lightweight fuel cell biplates and end plates.

2. Description of the Related Art

Fuel cells are presently used to convert hydrogen rich fuel into electricity without burning the fuel. For example, methanol, propane, and similar fuels that are rich in hydrogen and/or pure hydrogen gas fuel cell systems have been developed which generate electricity from the migration of the hydrogen in those fuels across a membrane. Because these fuels are not burned, pollution from such fuel cells is quite low or non-existent.

These fuel cells are generally more than twice as efficient as gasoline engines because they run cooler without the need for insulation and structural reinforcement. Additionally, some fuel such as methanol, are relatively inexpensive.

Often, a fuel cell system comprises a plurality of discreet fuel cells stacked together, also known as a “fuel cell stack.” One of the major structural components of a fuel cell stack are end plates and biplates. The end plates generally define the ends of a fuel cell stack. All of the plates disposed between the end plates are biplates. A biplate is a two-sided component which is placed between the membrane electric assemblies (MEA) in a fuel cell stack. One side of the biplate is oriented to face an anode of one MEA, and other side of the biplate is oriented to face the cathode of another MEA. The biplate provides electrical contact to both of the MEA. It also acts to separate air or oxygen provided to the cathode of one MEA and the fuels provided to the anode of another MEA. As such it forms part of the fuel cell compartment containing either fuel or air.

The end plates of a fuel cell stack form the last fuel cell compartments on the stack. If cells are not stacked together, an end plate is simply a wall of the fuel cell. The end plate provides electrical contact between an electrode of the fuel cell and the electrical load which spans the fuel cell or stack of fuel cells. The end plate can simply be a singled ended biplate. Thus, both fuel cell components, biplates, and end plates, are electrically conductive elements. These plates were typically formed of machined graphite.

Fuel cell stacks designed for generation of electricity from hydrogen and air require some means for removing heat from the fuel cells. Thus, prior fuel cell stacks designed for the generation of electrical energy from hydrogen and air often use cooling plates inserted between biplates for the specific purpose of withdrawing heat from the stack. Additionally, such fuel cell systems were quite expensive and heavy because the plates were typically formed of machine graphite.

In other systems, where a liquid hydrogen rich fuel is used and recirculated through the fuel cell, the biplate and end plates were made from plastic because the recirculation of liquid fuel serves to remove the heat generated within the stack. Thus, these designs were less costly and lighter than the prior art machined graphite end plates and biplates.

### SUMMARY OF THE INVENTION

An aspect of at least one of the embodiments disclosed herein includes the realization that some heat resistant plastics can also be used to form end plates and biplates of a fuel cell or fuel cell stack and be used in fuel cell systems that do not include a recirculated liquid fuel. For example, such fuel cell systems can employ gaseous fuel and air. This results in a lightweight, low cost fuel cell in which avoids the additional liquid recirculation system for cooling purposes.

Accordingly, in accordance with one embodiment, a fuel cell configured to generate electrical energy from reactions of a gaseous fuel and air comprises a proton exchange membrane and at least one plate member configured to define a fuel flow area disposed between the plate member and a first side of the proton exchange membrane. The plate member comprises a main body member constructed of at least one of polyphthalamide, polyphenylene sulfide, and polyetheretherketone, and a liquid crystal resin.

Another aspect of at least one the embodiments disclosed herein includes the realization that where thermal plastic material is used for constructing a fuel cell plate, thermal conductivity of such thermal plastic can be enhanced sufficiently for gaseous fuel cell operation purposes by constructing the plate with at least about 30% of at least one of carbon fiber and carbon powder. By adding at least about 30% of carbon material, the thermal conductivity of many plastic materials can be enhanced sufficiently to provide thermal heat rejection directly from the plates at a sufficient rate to enable sustained operation of the fuel cell with gaseous fuels. For example, the carbon material can be added to any type of amorphous or crystalline thermoplastics including, for example, but without limitation, poly olefins such as high density polyethylene, and polypropylene; polyamide plastics; polycarbonates; polyesters including polyethylene terephthalate), and poly(butylene terephthalate; polyethers; phenolic resins; and polystyrenes including acrylonitrile-butadiene-styrene (ABS). Copolymers of the above materials can also be utilized. Additionally, such carbon material can be added to polyphthalanide, polyphenylene sulfide, PEEK or liquid crystal resin.

Thus, in accordance with at least one of the embodiments disclosed herein, a fuel cell plate assembly comprises a body comprising at least one of a polymeric thermoplastic material and a crystalline resin material. The body is configured to define a fluid flow area between a first surface of the body and a proton exchange membrane assembly. The body also includes at least about thirty percent by weight of at least one of carbon fiber and carbon particles.

In accordance, with at least another embodiment disclosed herein, a method is provided for molding a plate assembly for a fuel cell system. The method includes placing a conductive member unit in a mold, the conductive member unit comprising a plurality individual conductive members connected together. The method also includes introducing a flowable material into the mold so as to form a fuel cell plate member and mold the conductive members into the plate member.

In accordance with another embodiment, a method of operating a hydrogen and air fuel cell is provided. The method includes injecting a gaseous, hydrogen-rich fuel into a flow area of a fuel cell defined between a fuel cell plate and a proton exchange membrane assembly, wherein the fuel cell plate comprising at least one of a thermo plastic material and a crystalline resin material.

### BRIEF DESCRIPTION OF THE DRAWINGS

FIGS. 1-9 schematically illustrate prior art fuel cell systems.

FIG. 1 is a perspective view of a prior art fuel cell stack;

FIG. 2 is enlarged sectional view of a single fuel cell in the fuel cell stack of FIG. 1;

FIG. 3 illustrates a flow of hydrogen rich fuel into the fuel side of the fuel cell of FIG. 2 and a flow of air into the air side of the fuel cell of FIG. 2;

FIG. 4 illustrates a hydrogen rich fuel and air disposed on the fuel and air sides of the fuel cell of FIG. 2;

FIG. 5 illustrates the disassociation of electrons from protons of the fuel in the fuel cell of FIG. 2;

FIG. 6 illustrates the movement of the protons from the fuel having traveled through the membrane electrode assembly and the movement of electrons along the anode of the membrane electrode assembly and toward a load device;

FIG. 7 illustrates the electrons from the anode returning to a cathode of the membrane electrode assembly after having traveled through a load device;

FIG. 8 illustrates the reassociation of the electrons with the proton and a molecule of air on the air side of the fuel cell;

FIG. 9 illustrates the combined proton and air molecules leaving the air side of the fuel cell.

The features mentioned above in the summary of the invention, along with other features of the inventions disclosed herein, are described below with reference to the drawings of the preferred embodiments. The illustrated embodiments in the figures listed below are intended to illustrate, but not to limit the inventions. The drawings contain the following additional figures:

FIG. 10 is a perspective view of a fuel cell plate configured in accordance with at least one embodiment;

FIG. 11 is another perspective view of the fuel cell plate illustrated in FIG. 10;

FIG. 12 is an enlarged perspective view of conductive elements disposed on an inner side of the fuel cell plate illustrated in FIG. 10;

FIG. 13 is a modification of the fuel cell plate illustrated in FIG. 12 including conductive elements embedded in the base material of the fuel cell plate and with enhanced mounting structures for the conductive elements;

FIG. 14 is another perspective view of the fuel cell plate illustrated in FIG. 13 and illustrating a surface feature configured to cooperate with the gasket for sealing the fuel cell against a sealing surface;

FIG. 15 illustrates another modification of the fuel cell plate of FIG. 11 including elongated conductive elements mounted to the plate material;

FIG. 16 is an overall perspective view of the plate illustrated in FIG. 16;

FIG. 17 is another perspective view of the plate illustrated in FIG. 17 with the plate material illustrated as opaque;

FIG. 18a is a schematic illustration of the plates illustrated in FIGS. 10-17 used as an end plate; FIG. 18b is a schematic illustration of the use of the plates illustrated in FIGS. 10-17 as a biplate; FIG. 18c is a schematic illustration of another use of the plates of FIGS. 10-17 as biplates;

FIG. 19 is a schematic illustration of molding process that can be used to form any of the plates illustrated in FIGS. 11-18;

FIG. 20 is a schematic illustration of modification of the molding process illustrated in FIG. 19;

FIG. 21 is yet another modification of the molding process illustrated in FIG. 19;

FIG. 22 is a schematic illustration of a conductive mesh assembly that can be used with any of the plates and manufacturing processes illustrated in FIGS. 10-21;

FIG. 23 is a schematic illustration of a conductive element mesh assembly that can be used with the conductive element shapes illustrated in FIGS. 16-18.

### DETAILED DESCRIPTION OF THE PREFERRED EMBODIMENT

Devices which are configured to convert chemical energy into electrical energy are generally referred to as batteries. Fuel cells are a special class of batteries in which high-energy chemical reactants are continuously fed into the battery and the lower energy chemical products are continuous removed.

Batteries can comprise one or several individual cells. A single cell includes a negative electrode and a positive electrode. An electrolytic solution separates the electrodes. When the cell is discharging (converting chemical energy to electrical energy), an oxidation reaction occurs at the negative electrode (anode). At the positive electrode (cathode), a reduction reaction occurs during discharging.

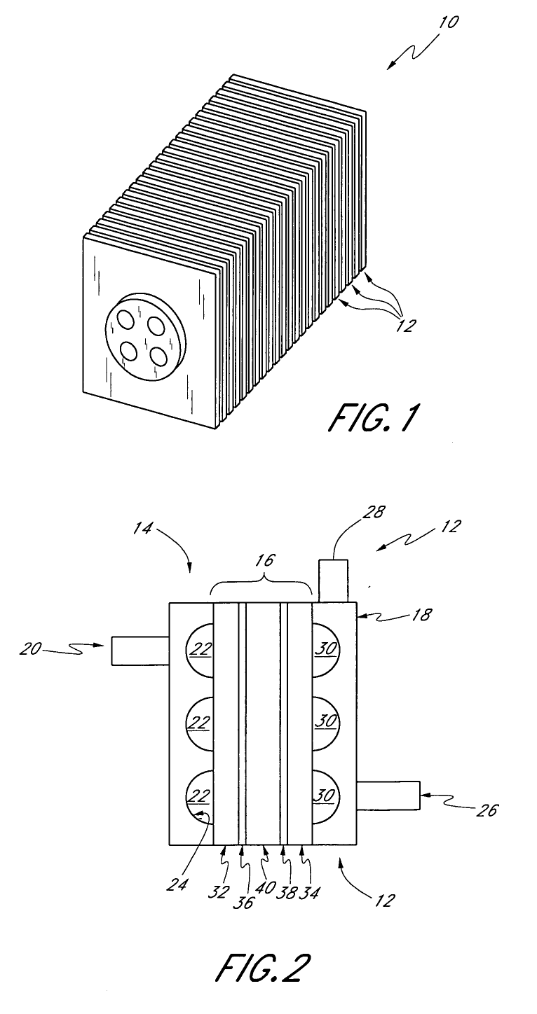

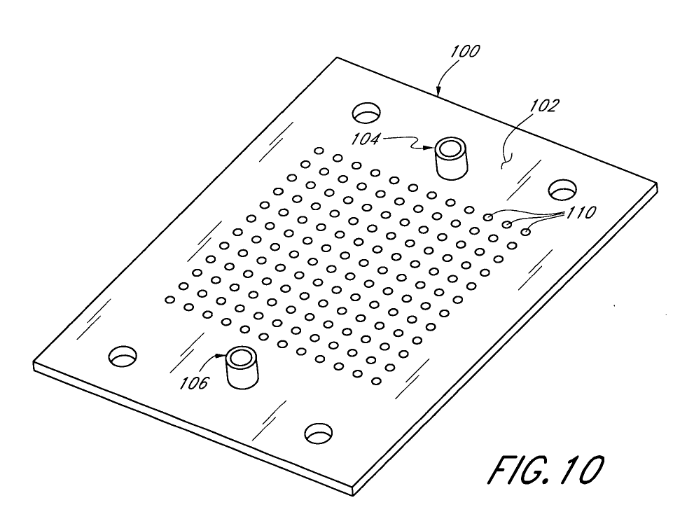

For the electrode reactions of any corresponding pair of anodes and cathodes (also known as an electrochemical couple), electrons pass from the anode, through an external circuit such as an electric motor or storage device, to the cathode. Completion of the circuit occurs when ionic species are transferred across the cell through the intervening electrolyte. The change from electronic conduction to ionic conduction occurs at the electrode and involves an electrochemical (Faradaic) reaction. However, electrons cannot pass through the electrolyte, or short circuiting will resort in cell self-discharge. An example of a known prior art hydrogen/air fuel cell is illustrated in FIGS. 1-9.

As shown in FIG. 1, a fuel cell stack 10 is made up of the plurality of individual fuel cells 12. Each fuel cell can be comprised of a pair of plates and a membrane electrode assembly. One plate defines a flow area between an inner surface of the plate and one surface of the membrane electrode assembly (MEA) while the other plate defines a second flow area between the second plate and other side of the membrane electrode assembly. The two flow areas are separated from each other. Thus, fuel can be supplied to one of the flow areas and air, or another oxygen carrying medium, can be supplied to the other flow area.

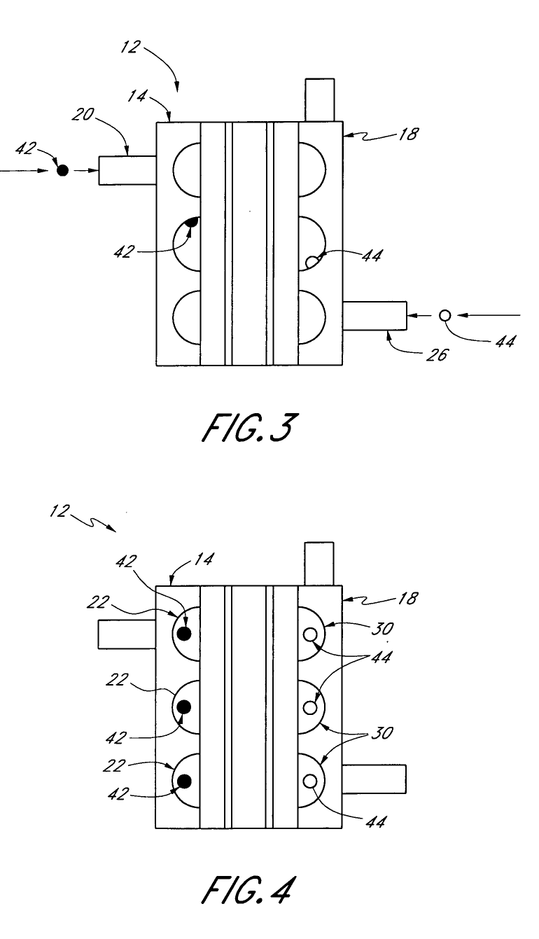

FIG. 2 illustrates an enlarged schematic sectional view of a single cell 12. Only a single cell is illustrated in FIG. 2 for simplicity purposes only. One of ordinary skill in the art understands how to use a plurality of the individual cells 12 to construct a fuel cell stack 10.

As shown in FIG. 2, the cell 12 includes a fuel-side plate 14, a membrane electrode assembly (MEA) 16 and air-side plate 18. The fuel-side plate 14 is typically constructed of machined graphite. The plate 14 defines a fuel inlet 20 and a fuel flow area 22. The fuel inlet 20 is connected to the fuel flow area 22. The fuel flow area 22 can be constructed from surface features on an inner surface 24 of the plate 14. For example, the fuel flow area 22 can be comprised of channels or other flow resistance or mixing features for generating a mixed and/or evenly spread flow of fuel through the flow area 22.

Plate 18 can be configured in a substantially or identical manner, depending on the type of fuel cell. In the illustrated example, the fuel cell stack 10 is configured to convert pure hydrogen gas into electricity through reaction with air. Thus, the plate 14 does not have an outlet for discharging material from the flow area 22. Rather, in this type of fuel cell, all of the supplied fuel is consumed.

However, the plate 18, because it is designed to receive air and to discharge the byproducts of the reaction, namely water, includes an air inlet 26 and an exhaust outlet 28. Additionally, similarly to the flow area 22, the plate 18 also defines a flow area 30 which can be constructed generally in accordance with the description set forth above with respect to the flow area 22. Additionally, in prior art systems, plates such as the plates 14 and 18 have been formed from machined graphite.

The membrane electrode assembly 16 typically comprises two electrodes, for example, an anode 32 and a cathode 34. The anode 32 and the cathode 34 are disposed so as to be in contact with the fuel flowing in flow areas 22 and the air flowing in the flow areas 30, respectfully. The MEA 16 also includes catalyst devices 36, 38 and a proton exchange membrane 40. The construction of these devices are well known in the art, however, a more detailed description is set forth below.

The anode 32 and the cathode 34 serve as the negative and positive electrodes, respectively. In operation, several processes are involved. The processes can be summarized as: gas transfer to reaction sites, electrochemical reaction at those sites, the transfer of ions and electrons, and their combination at the cathode.

In some designs, gas is diffused through the electrode leaving behind any impurities which may disrupt the reaction. Gases move toward the reaction sites based on the concentration gradient between the fuel flow areas 22 (high concentration) and the reaction sites (low concentration). Platinum, which is typically used as an electrode catalyst in the catalyst members 36, 38 cooperate with the electrode members 32, 34 and can together serve as the electrodes.

The concentration gradient refers to the difference between the concentration of free flowing gas in the flow areas 22, 30 and the concentration at the reaction sites in the platinum. This gradient varies depending on pressure and temperature of the gases and the diffusion coefficient of the electrode material. When gas comes near the reaction sites, the flow is dominated by a capillary action based on the reaction rates at the sites.

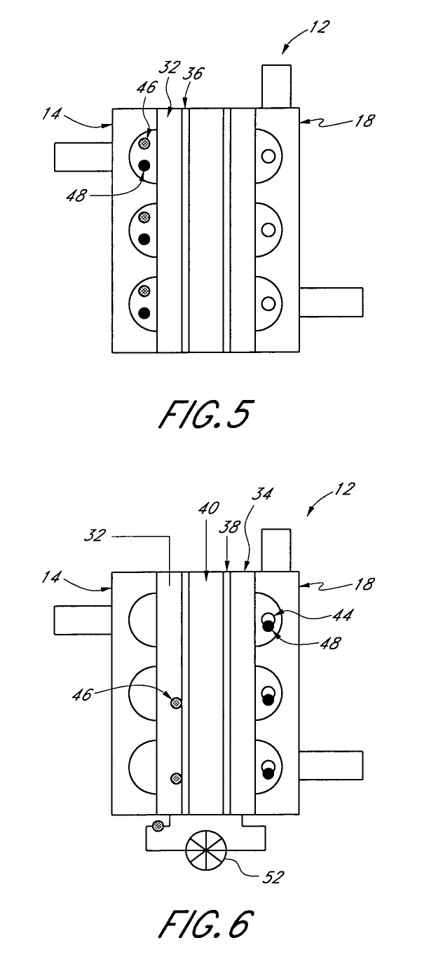

FIGS. 3 and 4 schematically illustrate the flow of hydrogen molecules 42 flowing into the flow areas 22 as well as the flow of air molecules, and in particular oxygen 44, flowing into the flow areas 30.

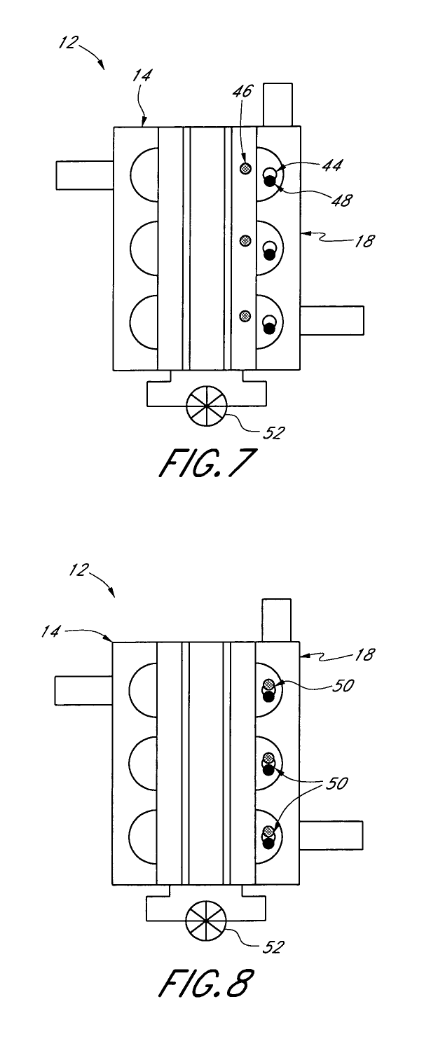

With reference to FIG. 5, the disassociation of electrons 46 from the protons 48 forming the previously introduced hydrogen molecule 42 (FIG. 4) is schematically illustrated. This disassociation actually occurs at reaction sites in the catalyst member 36. When the hydrogen molecules 42 reach the reaction sites within the catalyst 36, an electrochemical reaction occurs. At the catalyst layer 36, hydrogen molecules (H₂) disassociate so as to form a hydrogen ion (2H⁺) 48 and two electrons (2e⁻) 46.

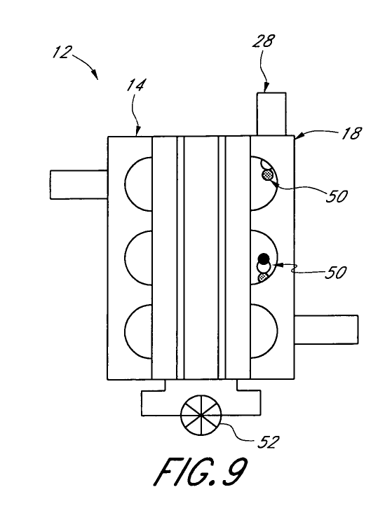

With reference to FIG. 6, the proton exchange membrane 40 allows the hydrogen ions 48 to pass therethrough, however, inhibits the electrons 46 from passing therethrough. The buildup of electrons 46 in the anode 32 generates a net negative charge at the anode.

Additionally, at the reaction sites in the catalyst member 38, the hydrogen ions (2H⁺) 48 combine with oxygen molecules (½O₂) 44 along with electrons 46 from the anode 32 (2e⁻) 46 to form water (H₂O) 50 (FIG. 8).

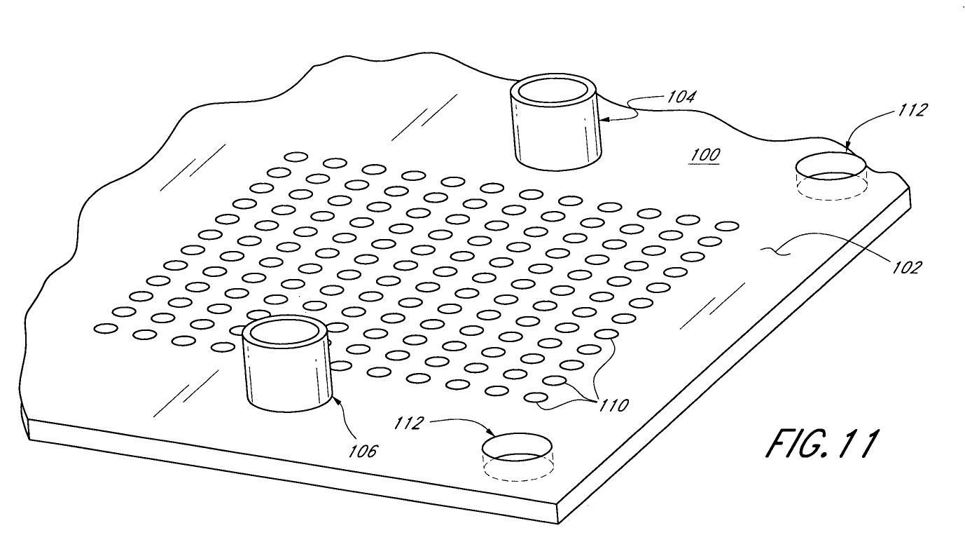

With continued reference to FIG. 6, the movement of the electrons 46 from the anode 32 to the cathode 34 can be applied to a load device, such as, for example, but without limitation, an electric motor 52. The electrons 46 are also drawn to the cathode 34 due to the positive charge on the hydrogen ions 48. FIG. 9 illustrates the discharge of the water molecules through the exhaust outlet 28.

As noted above, the plates 14, 18 typically have been composed of machined graphite. Machined graphite is relatively heavy and expensive to machine. Thus, fuel cell designs of the prior art have been burdened by the weight and cost associated with manufacturing machined graphite.

Additionally, as noted above, other designs for plates, such as the plates 14, 18, being comprised of plastics with graphite electrode components mounted therein have been proposed for use in liquid recirculation type fuel cell systems. In these systems, a liquid mixture of a hydrogen rich fuel is introduced through the inlet 20 (FIG. 2) so as to provide a source of hydrogen in the flow passages 22. In this type of design, a recirculation outlet (not shown) is attached to the flow areas 22 so as to allow this liquid hydrogen-rich fuel to flow into and out of the flow passages 22.

In one example, the liquid hydrogen rich fuel is a mixture of about 2-4% methanol and 96-98% water. The high thermal conductivity of water in this mixture was believed to be necessary to provide sufficient cooling of the associated fuel cell such that plastics could be used in place of machined graphite for forming the plates 14, 18. For example, U.S. Pat. No. 6,228,518 issued to Kindler, the entire contents of which is hereby expressly incorporated by reference, discloses such a fuel cell system.

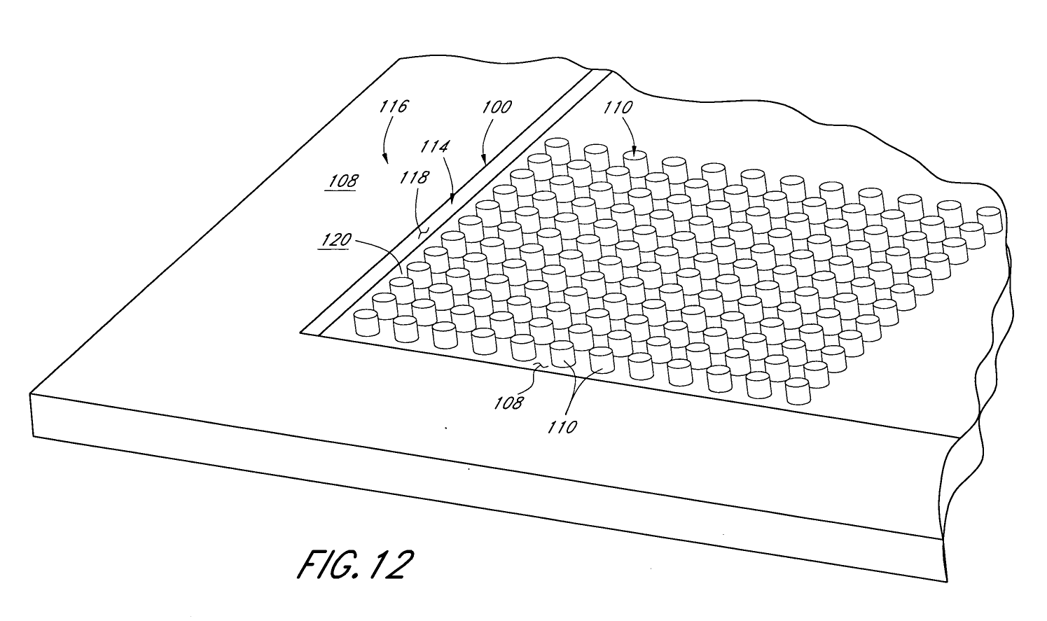

FIGS. 10-12 illustrate an embodiment of a fuel cell plate 100 constructed in accordance with at least one of the inventions disclosed herein. The illustrated plate 100 is configured to serve as an end plate of a fuel cell stack.

FIG. 10 illustrates a perspective view of the plate 100 with the outer surface or back surface 102 of the plate facing upwardly. The plate 100 includes passages 104, 106 for allowing connection to fuel flow source, an air flow source, discharge of exhaust gas, or discharge of recirculated fuel. Such use of the passages 104, 106 depends on the intended use of the plate 100. The passages 104, 106, however, extend through the plate 100 to an inner surface of the plate 108 (FIG. 12) described in greater detail below.

Additionally, the plate 100 includes a plurality of conductive elements 110 connected to the plate 100. The conductive elements 100 can be any shape, such as, for example, but without limitation, pins, walls, channels, rods, rectangular, square, cylindrical, circular, or other shapes. Additionally, the conductive elements 110 can be made from any conductive material, for example, but without limitation, graphite. The conductive elements 110 extend through the plate 100 and extend outwardly from the inner surface 108.

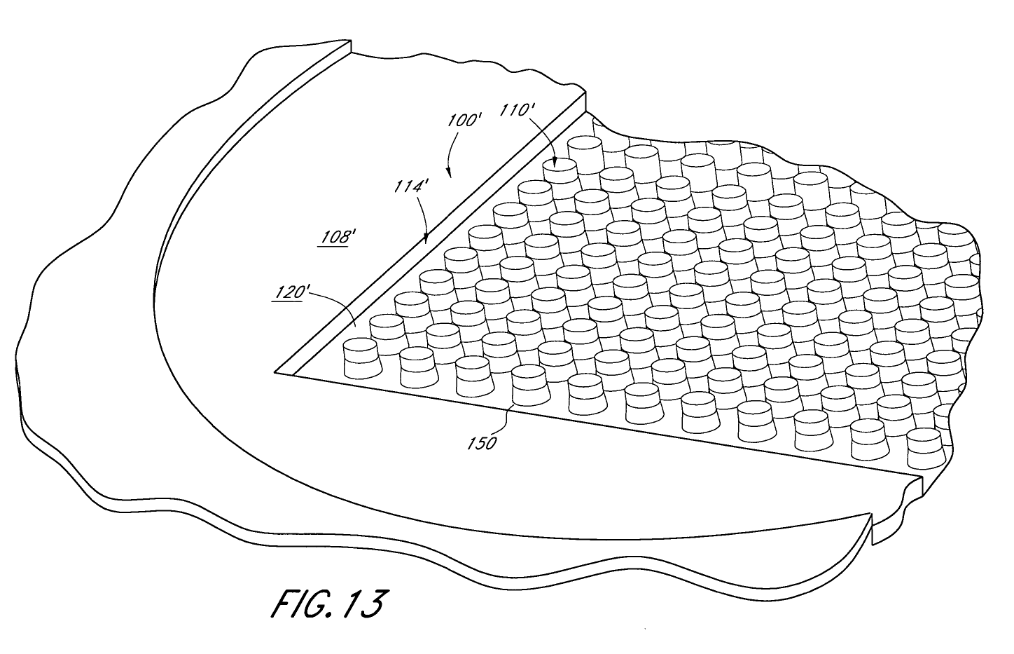

With reference to FIG. 11, the plate 100 can also include apertures 112 extending therethrough for connecting the plate 100 to other plates in the fuel cell stack. Connections using these types of apertures 112 are well known in the art.

With reference to FIG. 12, the inner surface 108 of the fuel cell plate 100 includes a recessed portion 114 into which the conductive elements 110 extend. In the illustrated embodiment, the inner surface 108 includes a raised portion 116, a peripheral wall 118 extending around the recessed portion 114 and a recessed surface 120.

The conductive elements 110 extend upwardly into the recessed portion 114. The volume of space within the recessed portion 120 and between the conductive elements 110 define a flow area for a fuel or other fluid for powering a fuel cell. For example, with reference to FIG. 2, the conductive elements 110 extending into the recessed portion 114 of the inner surface 108 of the fuel cell plate 100 provide obstructions to the flow of liquid or gas within the recessed area 114. Thus, these obstructions defined by the conductive elements 110 aid in mixing and spreading the flow of liquid or gas through the recessed portion 114. The combination of conductive elements 110 and the recessed portion 114 define flow areas that operate similarly to the flow areas 22 described above with reference to FIG. 2.

With reference again to FIG. 10, where the plate 100 is used as an end plate of a fuel cell stack, an additional conductive element can be disposed over the outer surface 102 so as to be in electrical contact with the ends of the electrical elements 110 that are exposed on the outer surface 102. Thus, the conductive element disposed over the outer surface 102 can serve as an electrode to which a load element, such as, for example, but without limitation, an electric motor, can be connected.

Where the fuel cell stack operates such that the elements 110 on the plate 100 are an anode, another plate (not shown) can be disposed on the other end of the fuel cell or fuel cell stack so as to serve as the cathode of the fuel cell or stack. Thus, an electrical circuit for driving a load device can be completed by connecting the load device to both the electrode defined by the plate 100 and the other electrode defined by the other plate that is not illustrated.

The plate 100 can advantageously be formed from a low weight material other than graphite. For example, the plate 100 can be formed from any polymeric thermoplastic material including poly olefins such as high density polyethylene, and polypropylene; polyamide plastics; polycarbonates; polyesters including polyethylene terephthalate), and poly(butylene terephthalate; polyethers; phenolic resins; and polystyrenes including acrylonitrile-butadiene-styrene (ABS). Copolymers of the above materials can also be utilized. Additionally, polyphthalamide, polyphenylene sulfide, PEEK or liquid crystal resin can also be used.

A further advantage is provided where the plate 100 is made from at least one of polyphthalamide, polyphenylene sulfide, polyetheretherketone (PEEK), or a liquid crystal resin. It has been found that these materials can withstand the temperatures generated by a hydrogen air fuel cell reaction without the need for liquid recirculation for cooling purposes. Thus, the plate 100 can be manufactured less expensively and provide a lower weight than a full graphite plate, and still avoid the need for liquid recirculation for cooling purposes.

Another advantage is achieved where the plate 100 is provided with at least about 30% of at least one of carbon fiber and carbon particles. As used herein, carbon fiber refers to any type of carbon material having an elongated shape, including longitudinal fibers, as well as other shapes made up of multiple fibers joined together. As used herein, carbon particles includes particles of carbon of any size on the order of millimeters, micrometers, smaller or larger. In this embodiment, the material forming the plate 100 can include at least one of poly olefins such as high density polyethylene, and polypropylene; polyamide plastics; polycarbonates; polyesters including polyethylene terephthalate), and poly(butylene terephthalate; polyethers; phenolic resins; and polystyrenes including acrylonitrile-butadiene-styrene (ABS), polyphthalamide, polyphenylene sulfide, and PEEK. Copolymers of the above materials can also be utilized. Additionally, liquid crystal resin can also be used.

By adding at least about 30% of at least one of carbon particles and fibers, the thermal conductivity of the plate 100 is enhanced sufficiently to allow the use of many more plastic materials which normally do not have a sufficient thermal conductivity to be used in a hydrogen/air fuel cell system.

FIG. 13 illustrates a modification of the plate 100 illustrated in FIGS. 10-12. The modification of FIG. 13 is identified generally by the reference numeral 100′. The same or similar components of the plate 100 are identified with the same reference numerals used to identify those components of the plate 100, except that a “′” has been added thereto. Additionally, those components that can be constructed in the same or similar manner are not described in further detail.

As shown in FIG. 13, the inner surface 108′ through which the conductive elements 110′ extend, includes additional reinforcements 150 for securing the conductive elements 110. In the illustrated embodiment, the reinforcements 150 define an enlarged base through which the conductive elements 110′ extend. These enlarged bases 150 are tapered in shape such that the size of the bases are larger where they intersect with the recessed wall 120′ and narrow in the direction in which the conductive elements 110′ extend. However, this is merely one example of one possible type of reinforcement 150 that can be used. Other shapes can also be used.

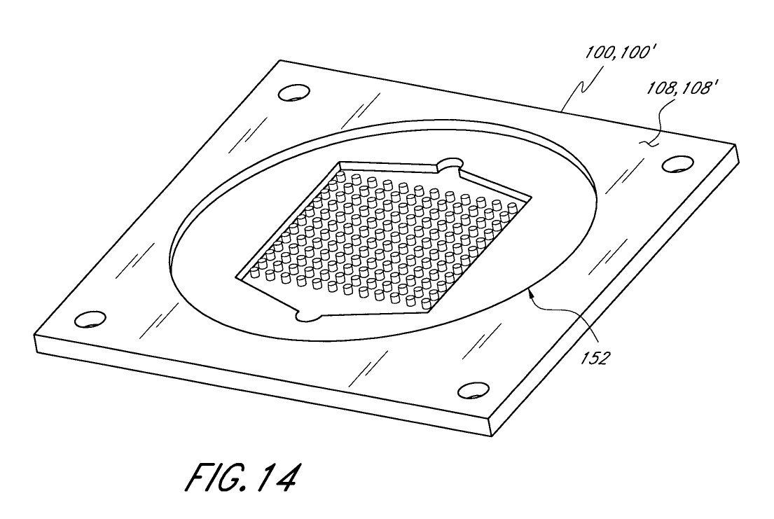

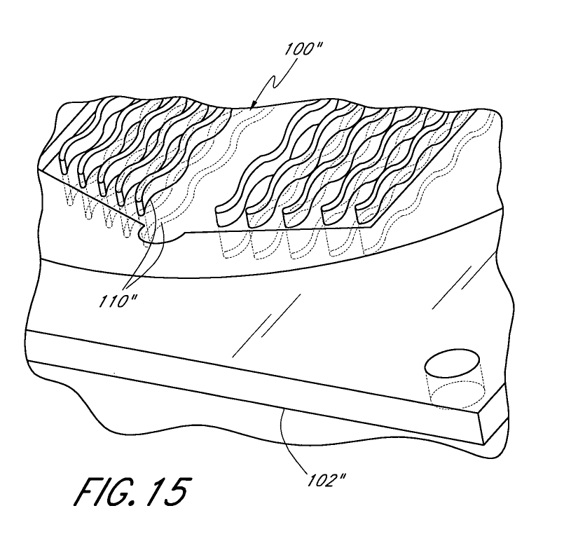

FIG. 14 illustrates another feature that can be used with either plates 100 or 100′. As shown in FIG. 14, the inner surface 108, 108′ can include an additional surface feature 152 for providing an enhanced seal against a gasket (not shown). For example, the surface feature 152 can be in the form of a ridge, an O-ring groove, or any other type of surface feature for providing enhanced seal against a gasket.

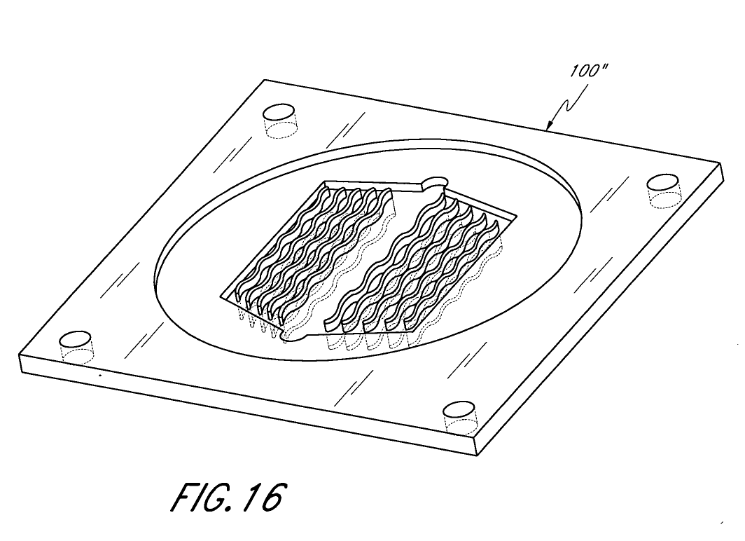

FIGS. 15-17 illustrate yet another modification of the plate 100, identified generally by the reference numeral 100″. The same or similar components of the plate 100″ are identified using the same reference numerals used to identify the corresponding components of the plates 100, 100′, except that a “″” has been added thereto.

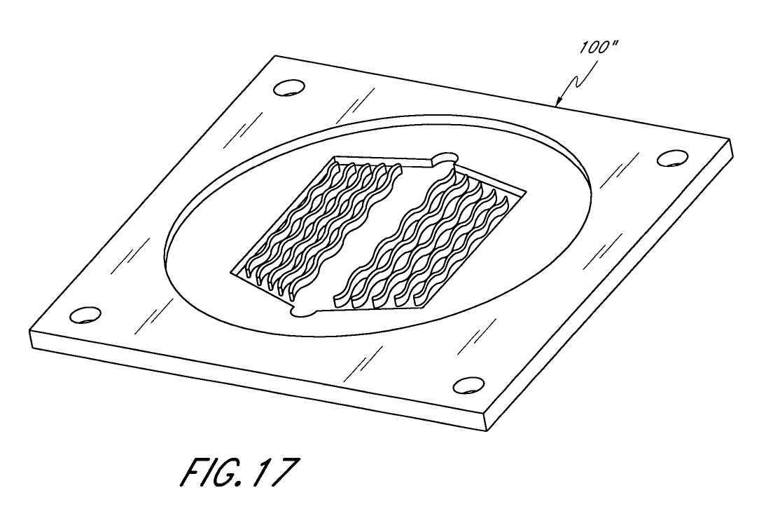

The plate 100″ is in the form of a “biplate.” Thus, the plate 100″ includes recessed portions 114″ on both of the surfaces 108″, 102″. Additionally, the plate 100″ includes conductive elements 110″ disposed in the recessed portions 114″ on both of the surfaces 108″, 102″. In the illustrated embodiment, the conductive elements 110″ are in the form of wavy walls. However, this is merely one additional example of one type of shape of conductive element 110, 110′, 110″ that can be used with the plates 100, 100′, 100″. Other shapes can also be used. FIGS. 16 and 17 illustrate additional views of the plate 100″.

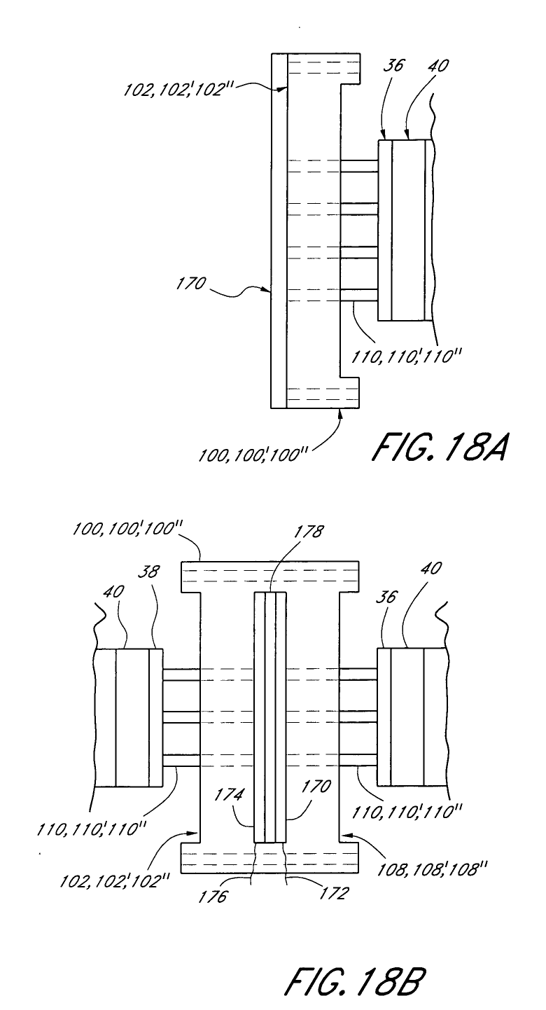

FIG. 18A illustrates a schematic illustration of how the plates 100, 100′, 100″ can be used as an end plate of a fuel cell or fuel cell stack. With regard to the description of FIG. 18, the basic description of a hydrogen/air fuel cell will not be repeated.

As noted above with reference to the descriptions of plates 100, 100′, 100″, the conductive elements 110, 110′, 110″ extend through the corresponding plate to the outer surface 102, 102′, 102″ thereof. At their inner ends, the conductive elements 110, 110′, 110″ are electrically connected to the catalyst member 36. Thus, electrons separated from the hydrogen rich fuel in the catalyst 36 can travel through the conductive elements 110, 110′, or 110″ to the outer surface 102, 102′, 102″. Optionally, although not illustrated, an additional conductive layer can be disposed between the conductive elements 110, 110′, 110″ in the catalyst 36 to provide enhanced conductivity therebetween.

In this design, an additional conductor 170 can be disposed on the outer surface 102, 102′, 102″ so as to provide an electrical conduit for electrons to flow from the conductive elements 110, 110′, 110′ to another cell in a fuel cell stack or to a load device. Optionally, additional insulators can be placed over the conductor 170 unintended discharge.

With reference to FIG. 18B, the plates 100, 100′, 100″ can also be used as biplates. As such, as noted above with particular reference to FIGS. 15, 17, when configured as such, the plates 100, 100′, 100″ include conductive elements 110, 110′, 110″ that extend from both surfaces 102, 102′, 102″ and surface 108, 108′, 108″. Hereinafter, it is to be understood that when specific reference is made to plate 100, unless indicated otherwise, it is intended that the reference numeral 100 shall represent all of the reference numerals 100, 100′, 100″. Similarly, where the reference numerals 102, 108, 110, as well as the other reference numerals, are used alone, it is intended that they correspond to those components of all three embodiments of the plates 100, 100′, 100″, although the reference numerals including the “′” and “″” will not be repeated.

With continued reference to FIG. 18B, the conductive elements 110 extending from the surface 108 are in contact with the catalyst element 36. Additionally, the conductive elements 110 extending through the surface 108, are in contact with the conductor 170 disposed within the plate 100. As such, the conductor 170 serves as an anode. Additionally, another electrical conductor 172 can connect the conductor 170 with another anode or a load device.

On the other hand, the conductive elements 110 extending through the surface 102 are in contact with the catalyst device 38. In this embodiment, the conductive elements 110 extending through the surface 102 are in contact with an additional conductor 174. Thus, the conductor 174 serves as a cathode. Similar to the conductor 172, an additional conductor 176 can be provided to provide an electrical contact to the cathode 174 on an outer surface of the plate 100.

In this embodiment to prevent a short, an insulator 178 is disposed between the conductors 174, 170. The insulator 178 can be made of any material. Additionally, the insulator 178 can simply be formed of the same polymeric or thermoplastic material used to form the body of the plate 100. As such, the insulator 178 does not need to be a separate member from the plate 100. Rather, the insulator 178 can be monolithic with the plate 100. As used herein, the term monolithic is intended to mean parts that are formed in one continuous piece, such as those resulting from a casting or molding process.

With reference to FIG. 18C, in another alternative arrangement, the plates 100, 100′, 100″ can be constructed such that the conductive elements 110, 110′, 110″ extend through both surfaces 102, 108. In this embodiment, both ends of the conductive elements 110 are in contact with catalyst devices 36 at both ends, such that the conductive elements 110 receive electrons from both ends. Optionally, the same design can be used where the conductive elements contact catalyst devices 38 at both ends thereof.

In the arrangement illustrated in FIG. 18C, the conductive elements 110 act as either an anode or a cathode. Thus, it is not necessary to divide the conductive elements 110 into separate parts and insulate them from each other. Rather, a single conductive element 110 can contact two anodes or two cathodes.

Additionally, fuel or air passages, identified by the reference numeral 104, can extend between both recessed portions 114, 114′, 114″ on both sides of the plate 100 so that fuel is disposed on both sides of the plate 100, or air is disposed on both sides of the plate 100. In this arrangement, an adjacent plate 100 would serve to support an opposite polarity electrode. For example, in this illustration, where the conductive elements 110 contact the catalyst 36, an adjacent plate 100 (not shown) would include conductive elements 110 contacting the catalyst device 38. As such, the other plate that is not shown would serve as a cathode. In this embodiment of the plates 100, an additional conductor 180 can optionally be inserted or embedded into the plate 100 to serve as an electrode or conductor for connecting the conductive elements 110 with another plate 100 or a load device.

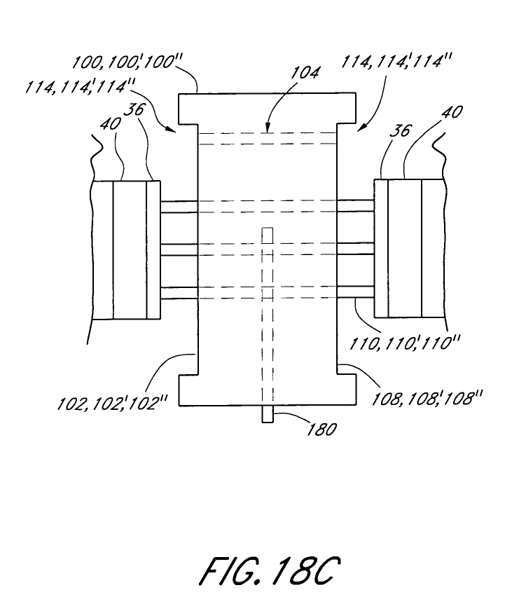

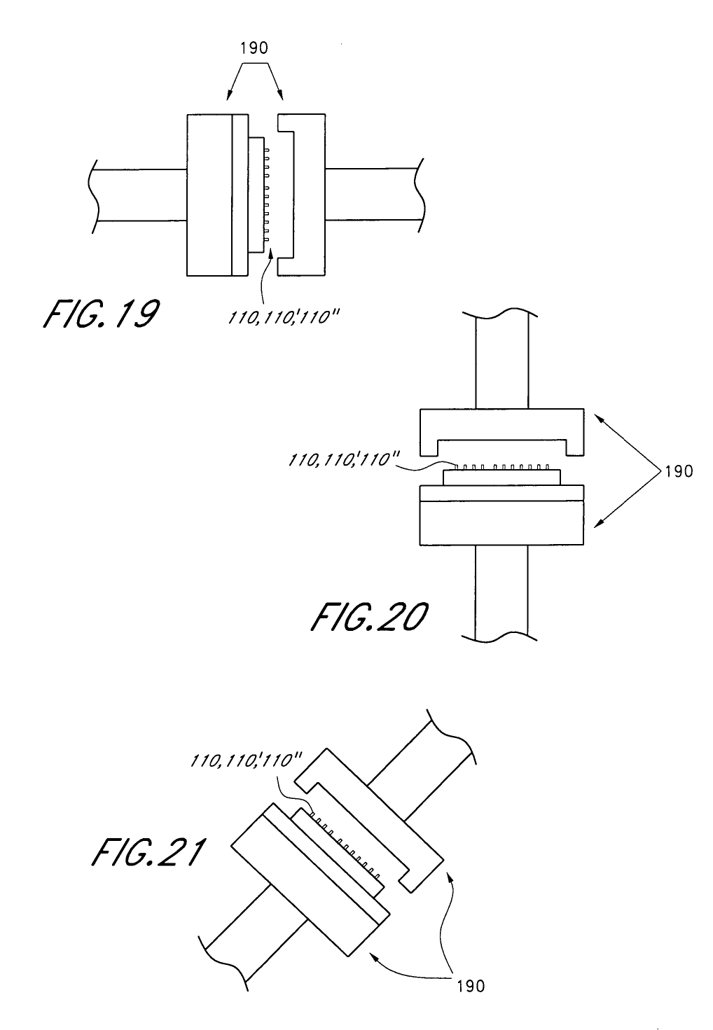

With reference to FIGS. 19-21, the above-described plates 100, 100′, 100″ can be conveniently manufactured through a molding process. For example, molds, identified generally by the reference numeral 190, can be shaped to produce any of the contours and features described above with reference to FIGS. 10-18. Additionally, internal elements, such as conductive elements 110, 110′, 110″ and/or conductors 170, 172, 174, 176, and insulator 178 (FIG. 18b), as well as conductor 180 can be placed in the mold while the mold is open. Thereafter, the mold can be closed and a flowable material, such as the polymeric material forming the plate 100, 100′, 100″ can be injected into the mold. The process of inserting any conductive elements, conductors, and/or insulators, can be done manually or automatically by robot.

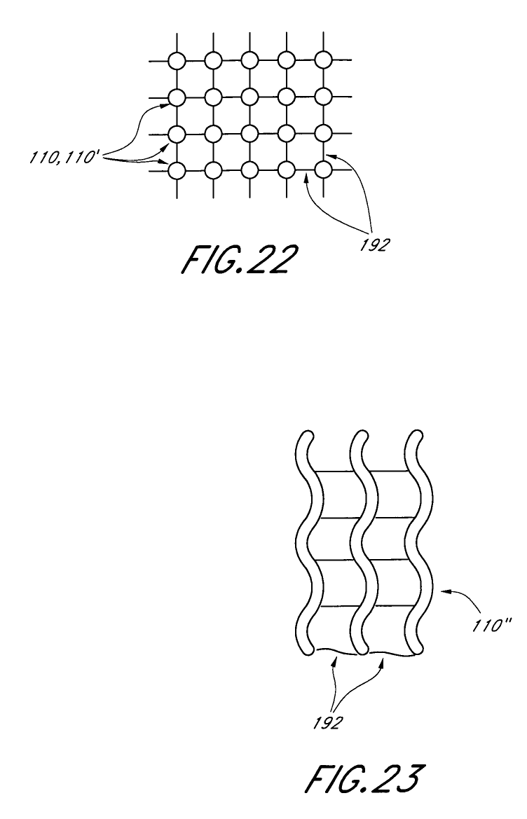

With reference to FIGS. 22 and 23, a further advantage is provided where a plurality of conductive elements 110, 110′, 110″ are connected together with at least one connecting member prior to insertion into the mold 190. For example, with reference to FIG. 22, a plurality of conductive elements 110, 110′ are connected together using a connector member 192.

The connector member 192 can be made of any material. In some embodiments, the connector member can be a conductor. In other embodiments, the connector member 192 can be an insulator. In some embodiments, the connector member 192 can be made from a material that will not melt during the injection molding process. In some embodiments, the connector member 192 can be made from a material that will partially melt during the injection molding process. Finally, it is also contemplated that the connector member 192 can be made from a material that completely melts during the injection molding process.

In these embodiments, optionally, the molds 190 can be configured to contact and thus secure the positioning of the conductive elements 110, 110 insulator member. In these embodiments, optionally, the molds 190 can be configured to contact and thus secure the positioning of the conductive elements 110, 110′ during the molding process. Thus, the connector member 192 can be used simply to facilitate the placement of the conductive elements 110, 110′ in the mold 190 prior to the closing of the mold 190. After the mold 190 is closed, the supportive function of the connector member 192 is no longer needed.

In other methods, the mold 190 can be configured such that it does not support the conductive elements 110, 110′ during the molding process. Thus, the connector member 192, in such an embodiment, can be made from a material that does not melt or does not completely melt during the injection molding process.

Depending on the material used to form the plate 100, the connector member 192 can be made from any thermoplastic material including, for example, but without limitation high density polyethylene, and polypropylene; polyamide plastics; polycarbonates; polyesters including polyethylene terephthalate), and poly(butylene terephthalate; polyethers; phenolic resins; and polystyrenes including acrylonitrile-butadiene-styrene (ABS), polyphthalamide, polyphenylene sulfide, and PEEK. Copolymers of the above materials can also be utilized. Additionally, liquid crystal resin can also be used.

Where it is desired that the connector member 192 does not completely melt during the injection molding process noted above with reference to FIGS. 19-21, the connector member 192 can be made from one of the above noted materials that has at least a higher melting point than that of the material used to form the plate 100. Where the connector member 192 is a conductor, the connector member 192 can serve as the conductor 180 illustrated in FIG. 18C.

Constructed as such, the conductive elements 110, 110′, and the connector member 192 form a mold insert unit that can quickly be inserted into a mold, such as the mold 190, thereby enhancing the speed of a manufacturing process for manufacturing the plates 100, 100′, 100″.

With reference to FIG. 23, the same technique of connecting conductive elements noted above with reference to FIG. 22, can also be used to form a mold insert with conductive elements 110″.

Optionally, the mold 190 can be configured to mold a plate 100, 100′, 100″ with holes through which conductive elements 110, 110′, 110″ are then inserted and anchored. For example, the conductive elements 110, 110′, 110″ can be secured through an interference fit, pressure, glues, or epoxies. Optionally, the surface of the conductive elements 110, 110′, 110″, can be coated with a variety of conductive coatings.

Although the present inventions have been described in terms of a certain preferred embodiments; other embodiments apparent to those of ordinary skill in the art also are within the scope of these inventions. Thus, various changes and modifications may be made without departing from the spirit and scope of the inventions. For instance, not all of the features, aspects and advantages are necessarily required to practice the present inventions. Accordingly, the scope of at least some of the present inventions is intended to be defined only by the claims that follow.

1. A fuel cell configured to generate electrical energy from reactions of a gaseous fuel and air comprising a proton exchange membrane and at least one plate member configured to define a fuel flow area disposed between the plate member and a first side of the proton exchange membrane, the plate member comprising a main body member constructed of at least one of polyphthalamide, polyphenylene sulfide, and polyetheretherketone, and a liquid crystal resin.

2. The fuel cell in accordance with claim 1 additionally comprising conductive members mounted in the at least one of polyphthalamide, polyphenylene sulfide and polyetheretherketone.

3. The fuel cell in accordance with claim 1 additionally comprising a catalyst material disposed between the proton exchange membrane and the flow area.

4. The fuel cell in accordance with claim 1 additionally comprising a second plate member configured to define a fluid flow are disposed between the second plate member and the a second side of the proton exchange membrane.

5. A fuel cell plate assembly comprising a body comprising at least one of a polymeric thermoplastic material and a crystalline resin material, the body configured to define a fluid flow area between a first surface of the body and a proton exchange membrane assembly, the body also including at least about thirty percent by weight of at least one of carbon fiber and carbon particles.

6. The fuel cell plate assembly in accordance with claim 5 additionally comprising at least one conductive member mounted in the body and extending from the first side of the body so as to be disposed in the flow area when the plate is connected to the proton exchange membrane assembly.

7. The fuel cell plate assembly in accordance with claim 6, wherein the conductive member extends through the body.

8. The fuel cell plate assembly in accordance with claim 6, wherein the body defines a first recessed area on the first surface and a second recessed area on a second surface opposite the first surface, the conductive members extending into both the first and second recessed areas.

9. The fuel cell plate assembly in accordance with claim 5, wherein the amount of at least one of carbon fiber and carbon particles is sufficient to raise the thermal conductivity of the body to transfer heat away from the plate member at a rate sufficient to support prolonged hydrogen/air reactions in a fuel cell assembly that is at least partially define by the fuel cell plate assembly.

10. The fuel cell plate assembly in accordance with claim 6, wherein the body defines a first recessed area on the first surface and a second recessed area on a second surface opposite the first surface, the conductive members extending into the first recessed area, and a second plurality of conductive members extending into the second recessed area.

11. A method of molding a plate assembly for a fuel cell system comprising placing a conductive member unit in a mold, the conductive member unit comprising a plurality individual conductive members connected together, introducing a flowable material into the mold so as to form a fuel cell plate member and mold the conductive members into the plate member.

12. The method according to claim 11, wherein the step of introducing comprises introducing at least one of a polymeric thermo plastic material and a crystalline resin material, while in a liquid state, into the mold.

13. The method according to claim 11, additionally comprising adding at least about thirty percent by weight of at least one of carbon fiber and carbon particles into the flowable material.

14. The method according to claim 13, wherein the step of adding comprises adding no more than about sixty percent by weight of the carbon fiber and carbon particles into the flowable material.

15. A method of operating a hydrogen and air fuel cell comprising:
injecting a gaseous, hydrogen-rich fuel into a flow area of a fuel cell defined between a fuel cell plate and a proton exchange membrane assembly, the fuel cell plate comprising at least one of a thermo plastic material and a crystalline resin material.

16. The method according to claim 15, wherein injecting comprises aerosolizing a liquid hydrogen-rich liquid fuel.

17. The method according to claim 15 additionally comprising vaporizing a liquid hydrogen rich fuel to form the gaseous hydrogen-rich fuel.
